(19) United States
(12) Patent Application Publication
(10) Pub. No.: US 2006/0089993 A1
(43) Pub. Date: Apr. 27, 2006

(54) Output device and input device

(76) Inventors: Shinichi Tsuruyama, Kagoshima-ken (JP); Yoichi Ikeda, Kagoshima-ken (JP)

Correspondence Address: MARTINE PENILLA & GENCARELLA, LLP, 710 LAKEWAY DRIVE, SUITE 200, SUNNYVALE, CA, 94085, US

(21) Appl. No.: 11/097,515

(22) Filed: Apr. 1, 2005

(30) Foreign Application Priority Data
Apr. 1, 2004 (JP) 2004-109117

(51) Int. Cl. G06F 15/16

(52) U.S. Cl. 709/227

(57) ABSTRACT

An output device comprising: a first unit that receives a request for an output service via a network; a second unit that receives a data processing service required for providing the requested output service via the network; and a third unit that provides the requested output service in a directly perceptible form based on data provided by the data processing service.

### CROSS-REFERENCE TO RELATED APPLICATIONS

The disclosure of Japanese Patent Application No. JP2004-109117 filed on Apr. 1, 2004 including the specification, drawings and abstract is incorporated herein by reference in its entirety.

### BACKGROUND OF THE INVENTION

1. Field of the Invention

The present invention relates to an output device and an input device, and more particularly, it relates to an output device and an input device which are used while being connected to a network.

2. Description of the Related Art

In recent years, in offices and homes, various output devices, such as a printer, a projector, a television monitor, a digital audio system or the like, have been used while being connected through a network such as a local area network (LAN).

Further, in recent years, there has been proposed a universal plug and play (UPnP) as a control protocol for various devices which are connected through the network. In the UPnP, for example, all devices connected to the network may be unitarily controlled by a control device which is called a control point. Further, in order to realize a new function by a combination of different services provided by a plurality of devices connected to the network, a sequence of requesting a plurality of devices to provide the services may be controlled by the control point. Specifically, for example, when a handheld PC as the control point requests a scanner to read an image, the image read by the scanner is stored in a predetermined storage device. Then, when the handheld PC requests a printer to print the stored image, a new function called a copy can be realized.

### SUMMARY OF THE INVENTION

An advantage of the present invention is that it provides an output device, an output method, an output program, an input device, an input method, an input program, an input system, and a data processing system, which are capable of providing highly advanced services by utilizing services provided by other devices connected to a network.

(1) In order to achieve the above-described advantage, there is provided an output device having a first unit that receives a request for an output service via a network, a second unit that receives a data processing service required for providing the requested output service, and a third unit that provides the requested output service in a directly perceptible form based on data provided by the data processing service.

When receiving the request for the output service, the output device requests another device to provide a data processing service required for providing the output service and completes the output service based on data provided by the data processing service. As a result, the output services provided by the respective output devices can be highly advanced.

(2) The output device may further have a fourth unit that detects a device which provides the data processing service and a fifth unit that notifies another device connected to the network of the output service including the data processing service detected by the fourth unit. The second unit may receive the data processing service from the device detected by the fourth means.

According to this configuration, the output service provided by the output device that receives the data processing service provided by another device is notified to another device according to the detection result of the data processing service. Thus, even when the output device or the device that provides the data processing service is frequently connected to or disconnected from the network, the output service including the data processing service can be easily used by another device.

(3) The output service may be a process of forming an image on a predetermined medium.

(4) In order to achieve the above-described advantage, there is provided an output method having receiving a request for an output service via a network, receiving a data processing service required for providing the requested output service via the network, and providing the requested output service in a directly perceptible form based on data provided by the data processing service.

(5) In order to achieve the above-described object, there is provided an output program product which causes an output device to function as a first unit that receives a request for an output service via a network, a second unit that receives a data processing service required for providing the requested output service via the network, and a third unit that provides the requested output service in a directly perceptible form based on data provided by the data processing service.

(6) In order to achieve the above-described object, there is provided a data processing system including a first device that provides a data processing service via a network and a second device that receives a request for an output service via the network, receives the data processing service from the first device via the network, and provides the requested output service in a directly perceptible form based on data provided by the data processing service.

(7) In order to achieve the above-described object, there is provided an input device including a first unit that receives a request for an input service via a network, a second unit that performs a process of inputting information in a directly perceptible form as a process corresponding to a portion of the requested input service, a third unit that receives a data processing service with respect to data representing the input information via the network, and a fourth unit that provides the requested input service based on data provided by the data processing service.

When receiving the request for the input service, the input device requests another device to provide a data processing service required for providing the input service and completes the input service based on data provided by the data processing service. Thus, the input services provided by the respective input devices can be highly advanced.

(8) The input device may further have a fifth unit that detects a device which provides the data processing service and a sixth unit that notifies another device connected to the network of the input service including the data processing service detected by the fifth unit. The second unit may receive the data processing service from the device detected by the fourth unit.

According to this configuration, the input service provided by the input device which receives the data processing service provided by another device is notified to another device based on the detection result of the data processing service. Thus, even when the input device or the device that provides the data processing service is frequently connected to or disconnected from the network, the input service including the data processing service can be easily used by another device.

(9) The input service may be a process of generating image data through the conversion of an optical image and outputting generated image data.

(10) In order to achieve the above-described object, there is provided an input method having receiving a request for an input service via a network, performing a process of inputting information in a directly perceptible form as a process corresponding to a portion of the requested input service, receiving a data processing service with respect to data representing the input information via the network, and providing the requested input service based on data provided by the data processing service.

(11) In order to achieve the above-described advantage, there is provided an input program product which causes an input device to function as a first unit that receives a request for an input service via a network, a second unit that performs a process of inputting information in a directly perceptible form as a process corresponding to a portion of the requested input service, a third unit that receives a data processing service with respect to data representing the input information via the network, and a fourth unit that provides the requested input service based on data provided by the data processing service.

(12) In order to achieve the above-described advantage, there is provided a data processing system having a first device that provides a data processing service via a network and a second device that receives a request for an input service via a network, performs a process of inputting information in a directly perceptible form as a process corresponding to a portion of the requested input service, receives a data processing service with respect to data representing the input information from the first device via the network, and provides the requested input service based on data provided by the data processing service.

Moreover, the respective functions of the plurality of units are implemented by hardware resources whose functions are specified by the configurations themselves, hardware resources whose functions are specified by programs, or combinations thereof. Further, the respective functions of the plurality of units are not limited to those implemented by physically independent hardware resources.

### BRIEF DESCRIPTION OF THE DRAWINGS

FIG. 1 is a block diagram according to an embodiment of the invention;

FIG. 2 is a schematic view showing a network according to the embodiment of the invention;

FIG. 3 is a flowchart according to the embodiment of the invention;

FIG. 4 is a schematic view according to the embodiment of the invention; and

FIG. 5 is a schematic view according to the embodiment of the invention.

### DETAILED DESCRIPTION OF THE INVENTION

Hereinafter, as regards an output device, an output method, an output program, an input device, an input method, an input program, and a data processing system, the best mode for carrying out the invention will be described with reference to the drawings.

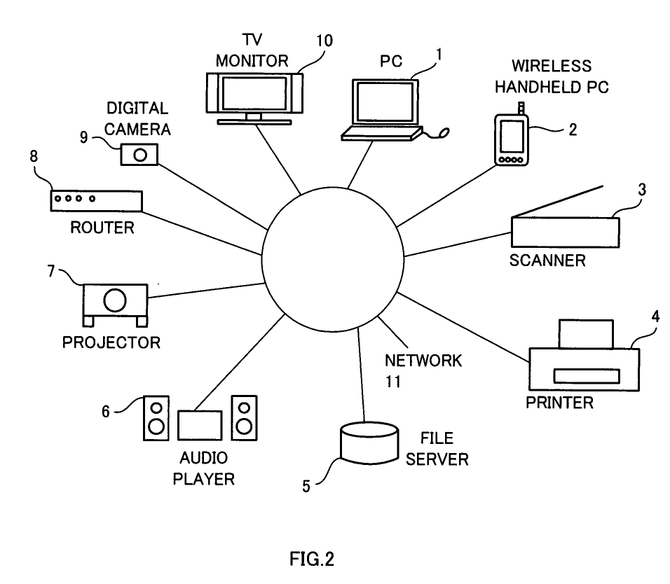

An output device and an input device according to an embodiment of the invention are used while being connected to an UPnP network which constitutes a data processing system shown in FIG. 2. As the output devices that provide output services in a perceptible form, for example, a printer 4, an audio player 6, a projector 7, a television (TV) monitor 10, a digital picture frame (not shown), and the like are exemplified. As the input devices that provide services of inputting information in a perceptible form, for example, a scanner 3, a digital camera 9, an audio recorder (not shown), and the like are exemplified. In addition, as devices that request the output devices for the output services and request the input devices for the input services, for example, a personal computer (PC) 1, a wireless handheld PC 2, a cellular phone (not shown), and the like are exemplified, which serve as control points.

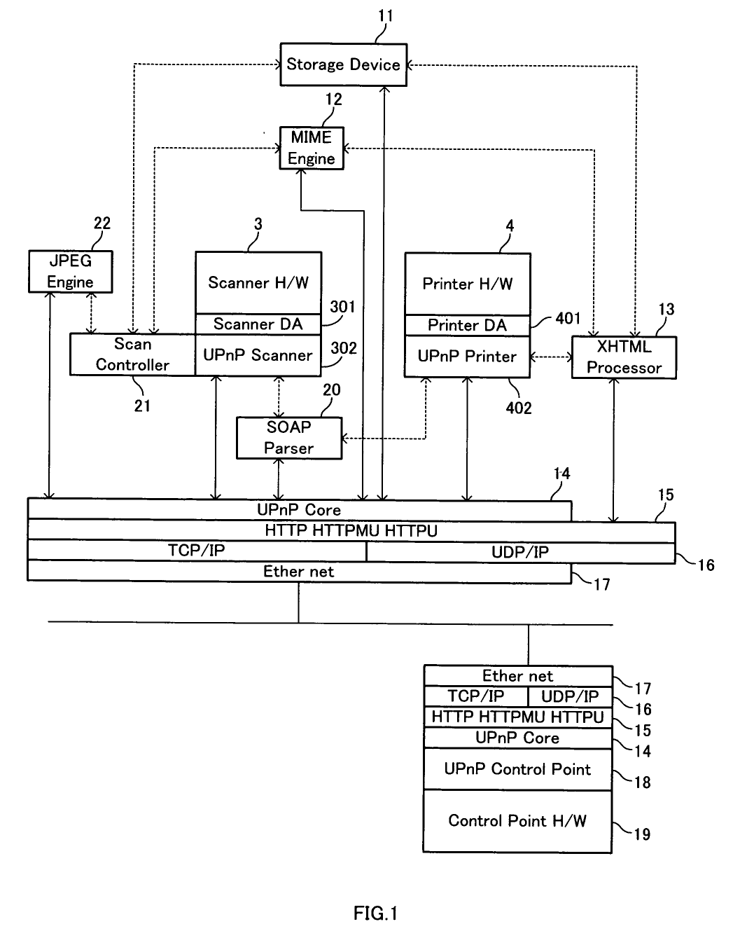

FIG. 1 is a block diagram showing a configuration of software of a data processing system according to an embodiment of the invention. The communications between the devices are performed through protocols of Ethernet 17 (Ethernet is Registered Trademark), TCP/IP 16, and HTTP 15. An UPnP core 14 is a module for performing respective steps defined by a UPnP device architecture. The UPnP core 14 is mounted in all devices connected to the UPnP network. The UPnP core 14 may be used in common for all types of devices defined by a device control protocol (DCP).

In the scanner 3, a scanner DA 301, an UPnP scanner 302, and a scan controller 21 are mounted.

The scanner DA 301 is a module which directly controls the hardware of the scanner 3. The scanner DA 301 is designed for each specification of the hardware of the scanner 3. Specifically, for example, the scanner DA 301 performs a photoelectric conversion on an optical image of a manuscript to output image data by performing an on/off control of a light source that irradiates the manuscript, a control of a driving signal such as a shift pulse or the like of a linear image sensor that reads the manuscript, a control of a motor that drives a carriage for moving the linear image sensor with respect to the manuscript, and the like.

The UPnP scanner 302 is a module that communicates with the scanner DA 301, the UPnP core 14, and the scan controller 21. The UPnP scanner 302 is designed based on the DCP, without depending on the hardware configuration of the scanner 3, and may be used in common for all scanner-type devices. The UPnP scanner 302 serves as an interface between a group of modules peculiar to the scanner-type devices and the UPnP core 14. The UPnP scanner 302 manages a scan service by receiving messages including actions and state variables defined by the DCP from other devices via the UPnP core 14 or the like and analyzing the received messages to call predetermined functions of the scanner DA 301 and the scan controller 21 or by acquiring output data from the scanner DA 301 and the scan controller 21 to transmit acquired data to other devices via the UPnP core 14 or the like.

The scan controller 21 is a module that controls a destination of scan data outputted from the scanner DA 301. The scan controller 21 does not depend on the hardware configuration of the scanner 3 and may be used in common for all scanner-type devices. For example, the scan controller 21 transmits scan data outputted from the scanner DA 301 to a JPEG engine 22 and requests the JPEG engine 22 to process a conversion of a raw data format into a JPEG format. In addition, the scan controller 21 transmits scan data converted into the JPEG format by the JPEG engine 22 to an address assigned by the UPnP scanner 302.

In the printer 4, a printer DA 401 and an UPnP printer 402 are mounted.

The printer DA 401 is a module that directly controls the hardware of the printer 4 based on printing data. The printer DA 401 is designed for each specification of the hardware of the printer 4. Specifically, for example, the printer DA 401 performs a control of a piezoelectric element mounted on a printer head, a control of a motor that reciprocally moves the printer head, a control of a paper transfer mechanism, and the like based on printing data.

The UPnP printer 402 is a module that communicates with the printer DA 401, the UPnP core 14, and an XHTML processor 13. The UPnP printer 402 is designed based on the DCP, without depending on the hardware configuration of the printer 4, and may be used in common for all printer-type devices. The UPnP printer 402 serves as an interface between a group of modules peculiar to the printer-type devices and the UPnP core 14. The UPnP printer 402 manages a print service by receiving messages including actions and state variables defined by the DCP from other devices via the UPnP core 14 or the like and analyzing the received messages to call the functions of the printer DA 401 and the XHTML processor 13 or by acquiring the state variables from the printer DA 401 to transmit the acquired state variables to other devices via the UPnP core 14 or the like.

The XHTML processor 13, a SOAP parser 20, the JPEG engine 22, and a MIME engine 12 are configured to exchange messages with other modules via the UPnP core 14, the HTTP 15, the TCP/IP 16, and the Ethernet 17 and may be mounted in any device. Specifically, the XHTML processor 13, the SOAP parser 20, the JPEG engine 22, and the MINE engine 12 have APIs which can be controlled from other devices than the devices, in which the functions are mounted, by using the messages including the actions defined by a DDD (Device Description Document) and a SDD (Service Description Document) of the UPnP.

The XHTML processor 13 is a module that communicates with the UPnP printer 402, a storage device 11, and the MIME engine 12 by HTTP and converts data to be printed of an XHTML format into data with no tag. The XHTML processor 13 may be mounted in, for example, the printer 4, a file server 5, the PC 1 or the wireless handheld PC 2, which serves as the control point, or the combination of the plurality of devices.

The SOAP parser 20 is a module that parses a SOAP description when the action is executed. The SOAP parser 20 is used in common for all types of devices defined by the DCP. The SOAP parser 20 may be mounted in, for example, the scanner 3, the printer 4, the file server 5, or the combination of the plurality of devices.

The JPEG engine 22 is a module that converts the raw data format of scan data outputted from the scanner DA 301 into the JPEG format. The JPEG engine 22 is used in common for all types of devices defined by the DCP. The JPEG engine 22 may be mounted in, for example, the scanner 3, the file server 5, the PC 1 or the wireless handheld PC 2, which serves as the control point, or the combination of the plurality of devices.

The MIME engine 12 is a module that converts a MIME data format of data to be printed into the JPEG data format and converts scan data from the JPEG data format into the MIME data format. The MIME engine 12 is used in common for all types of devices defined by the DCP. The MIME engine 12 may be mounted in, for example, the scanner 3, the file server 5, the PC 1 or the wireless handheld PC 2, which serves as the control point, or the combination of the plurality of devices.

A storage device 11 is a device that provides a storage area in which data is temporally stored at the time of the conversion of the data format. As a device serving as the storage device 11, for example, in addition to the device serving as the control point, such as the PC 1 or the wireless handheld PC 2, the file server 5 is exemplified.

Hereinafter, the functions of the respective modules will be described in detail by way of specified examples of services.

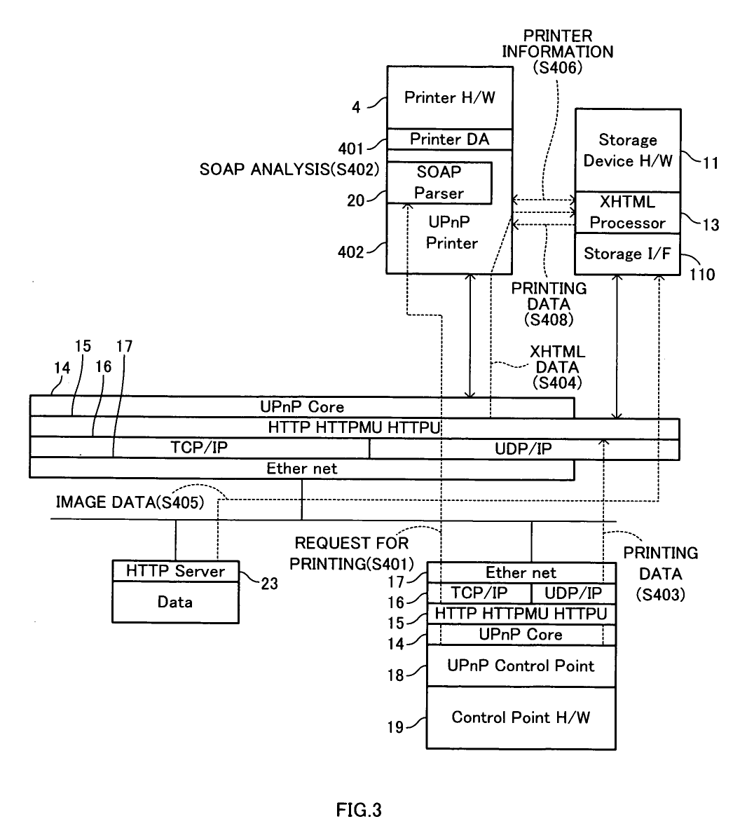

FIG. 3 shows a flow of a process of providing an XHTML-Print service by the printer 4 in cooperation with the storage device 11. In this process, a control point 19 is, for example, the wireless handheld PC 2, the storage device 11 is, for example, the PC 1, and an HTTP server 23 is, for example, the file server 5.

First, the control point 19 transmits a request for printing to the printer 4 (S401). At this time, it is assumed that a reference object scheme is assigned with respect to the request for printing. The transmission of the request for printing corresponds to a request of an output service as claimed in claims.

The request for printing is received by the UPnP printer 402 via the UPnP core 14 or the like. When receiving the request for printing, the UPnP printer 402 calls the SOAP parser 20 and instructs the SOAP parser 20 to parse the request for printing described according to the SOAP (S402). Based on the parsing result by the SOAP parser 20, the UPnP printer 402 detects that data to be printed has the XHTML format.

Next, the control point 19 posts data to be printed having the XHTML format to the printer 4 by HTTP (Step 403).

When receiving data to be printed, the printer 4 analyzes the data having the XHTML format and determines that printing data cannot be created. Accordingly, the UPnP printer 402 transmits XHTML data to the storage device 11 and requests the storage device 11 to converts data to be printed having the XHTML format into a format of printing data (Step 404). At this time, by using a SSDP (Simple Service Discovery Protocol), the UPnP printer 402 knows which device connected to the UPnP network provides a service of converting data having the XHTML format into printing data (hereinafter, referred to as a printing data conversion service). The SSDP is a simple multicast discovery protocol in which a HTTP header is extended. In a discovery packet of the SSDP, a link to the DDD (Device Description Document) described in an XML format is included. In the DDD, an URL for referring to a service type defined by UPnP Forum, in addition to a device type, a manufacturer name, a model name, and the like, is described. By using the URL, the SDD (Service Description Document) in which the service functions are described in detail in the XML format can be acquired.

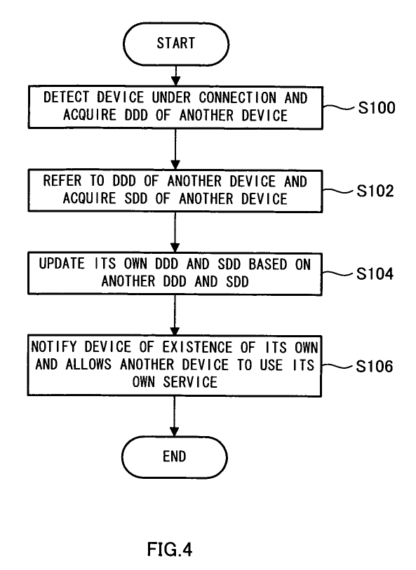

FIG. 4 is a schematic view showing an output service and a data processing service according to the embodiment of the invention. Here, the DDD and SDD of the printer 4 and storage device 11 will be described with reference to FIG. 4. The storage device 11 defines the printing data conversion service and the detail contents thereof (the actions, the state variables, and the like) in the DDD and SDD in order to notify other devices such as the printer 4 and the like of the service. When detecting the printing data conversion service provided by the storage device 11 through the SSDP (S100 and S102), the printer 4 defines the service as a service to be provided for oneself in the DDD and SDD (S104). When the service which can be provided by the printer 4 is multicast to other devices through the SSDP (S106), the control point 19 requests the printer 4, which provides the printing data conversion service for oneself, to the XHTML-Print service via the UPnP network. Up to now, the DDD and SDD of the printer 4 and storage device 11 are described.

In the storage device 11 that receives data to be printed having the XHTML format from the UPnP printer 402, the XHTML processor 13 acquires image data from the URL described in data to be printed (S405). In FIG. 3, an example in which image data is acquired from the HTTP server 23 is shown. Alternatively, the XHTML processor 13 may acquire image data from other devices such as the PC 1, the wireless handheld PC 2, and the like.

The XHTML processor 13 acquires information required for converting data to be printed having the XHTML format into printing data by communicating with the UPnP printer 402 of the printer 4 (S406). When acquiring the required information, the XHTML processor 13 performs a layout process and a rendering process based on the information and converts data to be printed having the XHTML format into printing data. This printing data conversion service corresponds to a data processing service as claimed in claims. The XHTML processor 13 transmits the printing data to the UPnP printer 402 via the HTTP 15 or the like (S408). By the transmission of printing data, the print data conversion service by the storage device 11 via the UPnP network is provided.

In the printer 4 that receives printing data, the UPnP printer 402 passes printing data to the printer DA 401 and printing is performed under the control of the printer DA 401. As a result, an image represented by data to be printed is formed on a printing paper and thus the XHTML-Print service by the printer 4 is completed.

As described above, when receiving the request for the output service, the output device such as the printer 4 requests another device to provide a data processing service required for providing the output service and completes the output service based on data provided by the data processing service. Thus, the output services provided by the respective output devices can be highly advanced.

In addition, the output service provided by the output device that receives the data processing service provided by another device is notified to another device by the SSDP based on the detection result of the data processing service through the SSDP. Thus, even when the output device or the device that provides the data processing service is frequently connected to or disconnected from the network, the output service including the data processing service can be easily used by other devices such as the control points.

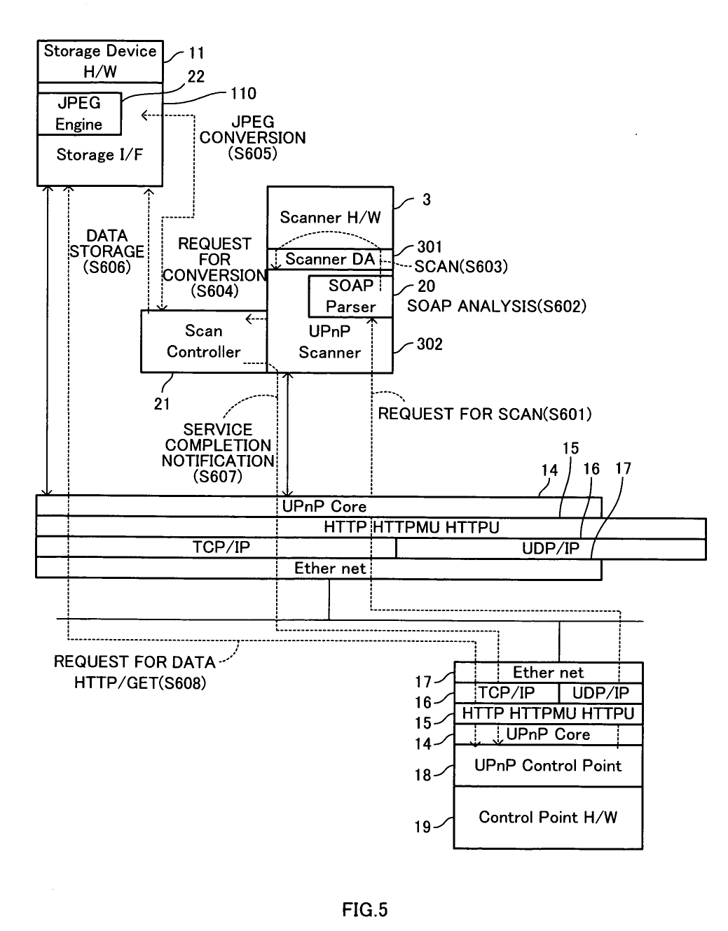

FIG. 5 is a schematic view illustrating an input service and a data processing service according to the embodiment of the invention. FIG. 5 also shows a flow of a process of providing an UPnP Scan service by the scanner 3 in cooperation with the storage device 11. In this process, the control point 19 is, for example, the wireless handheld PC 2, and the storage device 11 is, for example, the PC 1, the file server 5 or the like.

First, the control point 19 transmits a request for scanning to the scanner 3 (S601). At this time, a pull scheme is assigned with respect to the request for scanning. The transmission of the request for scanning corresponds to a request of an input service as claimed in claims.

The request for scanning is received by the UPnP scanner 302 via the UPnP core 14 or the like. When receiving the request for scanning, the UPnP scanner 302 calls the SOAP parser 20 and instructs the SOAP parser 20 to parse the request for scanning described according to the SOAP (S602). Based on the parsing result by the SOAP parser 20, the UPnP scanner 302 detects that a request for a service of providing scan data having the JPEG format (hereinafter, referred to as a scan service) is received from the control point 19.

Next, the UPnP scanner 302 passes various parameters acquired at the time of the reception of the request for scanning to the scanner DA 301. Then, the scanner 3 reads the manuscript and generates scan data having a raw format under the control of the scanner DA 301 and the scanner DA 301 outputs scan data to the UPnP scanner 302 (S603). Since the manuscript has directly perceptible image information such as photographs, characters, illustrations, and the like, the directly perceptible image information is inputted to the scanner 3 by the reading process on the manuscript.

When acquiring scan data having raw format, the UPnP scanner 302 passes scan data to the scan controller 21 and requests the scan controller 21 to perform the conversion process on scan data (S604). Through the process shown in FIG. 3, the UPnP scanner 302 knows which device connected to the UPnP network provides a service of the conversion of data having the raw format into data having the JPEG format (hereinafter, referred to as a scan data conversion service).

The scan controller 21 transmits scan data having the raw format to the storage device 11 and requests the storage device 11 to convert the raw format into the JPEG format, which is the data format detected by the UPnP scanner 302 through the analysis of the request for scanning (S605).

In the storage device 11 that receives the request for the scan data conversion service, the JPEG engine 22 converts scan data having the raw format into the JPEG format and transmits scan data having the JPEG format to the scan controller 21 (S605). This conversion process corresponds to a data processing service as claimed in claims.

The scan controller 21 stores received scan data having the JPEG format in the URL obtained by the UPnP scanner 302 through the analysis of the request for scanning (S606) and notifies the control point 19 of the service completion (S607). Through the notification of the service completion, the provision of the scan service by the scanner 3 is completed.

When receiving the notification of the service completion from the scanner 3, the control point 19 acquires scan data having the JPEG format from the storage device 11 through an HTTP/GET operation.

As described above, when receiving the request for the input service, the input device such as the scanner 3 or the like requests another device to provide the data processing service required for providing the input service and completes the input service based on data provided by the data processing service. Thus, the input services provided by the respective input devices can be highly advanced.

In addition, the input service provided by the input device that receives the data processing service provided by another device is notified to another device by the SSDP based on the detection result of the data processing service through the SSDP. Thus, even when the input device or the device that provides the data processing service is frequently connected to or disconnected from the network, the input service including the data processing service can be easily used by other devices.

In the above description, an example in which the invention is implemented by using the UPnP is described. Alternatively, the invention may be implemented in a different mode from the above description by using protocols which actively operate a plurality of network devices under the control of a specified control device. In addition, in the above description, an example in which the DCP (Device Control Protocol) is used for a communication protocol for receiving the data processing service from other devices in order to complete the service is described. Alternatively, the data processing service may be provided from other devices without using standard protocols.

What is claimed is:

1. An output device comprising:
a first unit that receives a request for an output service via a network;
a second unit that receives a data processing service required for providing the requested output service via the network; and
a third unit that provides the requested output service in a directly perceptible form based on data provided by the data processing service.

2. The output device according to claim 1, further comprising:
a fourth unit that detects a device which provides the data processing service; and
a fifth unit that notifies another device connected to the network of the output service including the data processing service detected by the fourth unit,
wherein the second unit receives the data processing service from the device detected by the fourth unit.

3. The output device according to claim 1 or 2,
wherein the output service is a process of forming an image on a predetermined medium.

4. An output method comprising:
receiving a request for an output service via a network;
receiving a data processing service required for providing the requested output service via the network; and
providing the requested output service in a directly perceptible form based on data provided by the data processing service.

5. An output program product which causes an output device to function as:
a first unit that receives a request for an output service via a network;
a second unit that receives a data processing service required for providing the requested output service via the network; and
a third unit that provides the requested output service in a directly perceptible form based on data provided by the data processing service.

6. A data processing system comprising:
a first device that provides a predetermined data processing service via a network; and
a second device that receives a request for an output service via the network, receives the data processing service from the first device via the network, and provides the requested output service in a directly perceptible form based on data provided by the data processing service.

7. An input device comprising:
a first unit that receives a request for an input service via a network;
a second unit that performs a process of inputting information in a directly perceptible form as a process corresponding to a portion of the requested input service;
a third unit that receives a data processing service with respect to data representing the input information via the network; and
a fourth unit that provides the requested input service based on data provided by the data processing service.

8. The input device according to claim 7, further comprising:
a fifth unit that detects a device which provides the data processing service; and
a sixth unit that notifies another device connected to the network of the input service including the data processing service detected by the fifth unit,
wherein the second unit receives the data processing service from the device detected by the fourth unit.

9. The input device according to claim 7 or 8,
wherein the input service is a process of generating image data through the conversion of an optical image and of outputting generated image data.

10. An input method comprising:
receiving a request for an input service via a network;
performing a process of inputting information in a directly perceptible form as a process corresponding to a portion of the requested input service;
receiving a data processing service with respect to data representing the input information via the network; and
providing the requested input service based on data provided by the data processing service.

11. An input program product which causes an input device to function as:
a first unit that receives a request for an input service via a network;
a second unit that performs a process of inputting information in a directly perceptible form as a process corresponding to a portion of the requested input service;
a third unit that receives a data processing service with respect to data representing the input information via the network; and
a fourth unit that provides the requested input service based on data provided by the data processing service.

12. A data processing system comprising:
a first device that provides a predetermined data processing service via a network; and
a second device that receives a request for an input service via the network, performs a process of inputting information in a directly perceptible form as a process corresponding to a portion of the requested input service, receives a data processing service with respect to data representing the input information from the first device via the network, and provides the requested input service based on data provided by the data processing service.
